(19) United States
(12) Patent Application Publication
(10) Pub. No.: US 2022/0075129 A1
(43) Pub. Date: Mar. 10, 2022

(54) OPTICAL CONNECTOR, OPTICAL CABLE, AND ELECTRONIC APPARATUS

(71) Applicant: SONY GROUP CORPORATION, TOKYO (JP)

(72) Inventors: HIROSHI MORITA, TOKYO (JP); KAZUAKI TOBA, KANAGAWA (JP); MASANARI YAMAMOTO, TOKYO (JP); YUSUKE OYAMA, TOKYO (JP)

(21) Appl. No.: 17/310,085

(22) PCT Filed: Jan. 16, 2020
(86) PCT No.: PCT/JP2020/001396

§ 371 Date: Jul. 15, 2021

(30) Foreign Application Priority Data
Jan. 25, 2019 (JP) 2019-010716

(51) Int. Cl. G02B 6/42; G02B 6/44

(52) U.S. Cl. CPC G02B 6/4204; G02B 6/44; G02B 6/4203

(57) ABSTRACT

To successfully reduce a coupling loss in optical power on the reception side that occurs due to an axial deviation on the transmission side. A connector body is included that includes a lens performing formation with respect to light that exits a light emitter, and causing light obtained by the formation to exit the lens. The lens includes a circular first lens portion situated in a center portion of the lens, and a ring-shaped second lens portion situated around an outer circumference of the first lens portion. The second lens portion changes a light path of a portion of input light when the portion of the input light is input to the second lens portion, such that the light path of the portion of the input light is oriented toward a direction of an optical axis of the lens, the input light being input light of which an optical axis deviates from the optical axis of the lens.

### TECHNICAL FIELD

The present technology relates to an optical connector, an optical cable, and an electronic apparatus. In particular, the present technology relates to, for example, an optical connector that makes it possible to reduce a loss in power of light due to an axial deviation.

### BACKGROUND ART

An optical connector using an optical coupling system that is a so-called optical coupling connector has been proposed in the past. (for example, refer to Patent Literature 1). In the optical coupling connector, each lens is mounted ahead of an end of a corresponding optical fiber with optical axes of the lens and the optical fiber being aligned with each other, an optical signal is formed into parallel light, and the parallel light is transmitted between facing lenses. In the optical coupling connector, optical fibers are optically coupled to each other in a non-contact state. Thus, a bad effect on the transmission quality due to, for example, dust entering a space between the optical fibers can also be suppressed, and this results in there being no need for a frequent and careful cleaning.

### CITATION LIST

### Patent Literature

Patent Literature 1: WO2017/056889

### DISCLOSURE OF INVENTION

### Technical Problem

In the optical connector using an optical coupling system, a deviation of a light path of an optical fiber from an optical axis of a lens, a so-called axial deviation, occurring on the transmission side may result in a significant coupling loss in optical power on the reception side when, for example, the optical fiber, such as a single-mode optical fiber, has a very small core diameter.

It is an object of the present technology to successfully reduce a coupling loss in optical power on the reception side that occurs due to an axial deviation on the transmission side.

### Solution to Problem

A concept of the present technology provides an optical connector that includes a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.

In the present technology, an optical connector that includes a connector body is included. The lens includes a circular first lens portion situated in a center portion of the lens, and a ring-shaped second lens portion situated around an outer circumference of the first lens portion. Further, in the second lens portion, a light path of a portion of input light is changed when the portion of the input light is input to the second lens portion, such that the light path of the portion of the input light is oriented toward a direction of an optical axis of the lens, the input light being input light of which an optical axis deviates from the optical axis of the lens.

As described above, in the present technology, the lens includes a circular first lens portion situated in a center portion of the lens, and a ring-shaped second lens portion situated around an outer circumference of the first lens portion. The second lens portion changes a light path of a portion of input light when the portion of the input light is input to the second lens portion, such that the light path of the portion of the input light is oriented toward a direction of an optical axis of the lens, the input light being input light of which an optical axis deviates from the optical axis of the lens. This makes it possible to reduce a coupling loss in optical power on the reception side that occurs due to the optical axis of input light deviating from the optical axis of the lens.

Note that, in the present technology, for example, the second lens portion may have a shape corresponding to a shape of a peak portion of a power distribution of the input light. In this case, the peak portion of the power distribution of the input light may have a shape of a single ring or two rings. When the second lens portion has a shape corresponding to a shape of a peak portion of a power distribution of input light, as described above, this makes it possible to change a path of light of a peak portion of a power distribution of the input light such that the path of the light is oriented toward a direction of the optical axis of the lens when the optical axis of input light deviates from the optical axis of the lens.

Further, in the present technology, for example, when the optical axis of the input light coincides the optical axis of the lens, all of the input light may be input to the first lens portion, and formation may be performed by the first lens portion with respect to the input light. In this case, the first lens portion may form the input light into collimated light. Such a configuration prevents a bad effect from being exerted by the second lens portion when the optical axis of input light coincides the optical axis of the lens.

Furthermore, in the present technology, for example, the connector body may include a first optical section to which the light emitter is fixed, and a second optical section that includes the lens. As described above, the connector body includes the first optical section and the second optical section, and this makes it possible to easily perform production.

Moreover, in the present technology, for example, the light emitter may be an optical fiber, and the connector body may include an insertion hole into which the optical fiber is inserted. When the connector body includes the insertion hole into which the optical fiber serving as the light emitter is inserted, as described above, this makes it possible to easily fix the optical fiber to the connector body.

Further, in the present technology, for example, the light emitter may be a light-emitting element that converts an electric signal into an optical signal. When the light emitter is the light-emitting element, described above, this results in there being no need for an optical fiber upon transmitting an optical signal coming from the light-emitting element. This makes it possible to reduce costs.

In this case, for example, the light emitter may be connected to the connector body, and the light exiting the light emitter may enter the lens with no change in a path of the light. Moreover, for example, the connector body may include a light path changing section used to change a light path, and a path of the light exiting the light emitter may be changed by the light path changing section to cause the light to enter the lens. Accordingly, for example, a path of light coming from the light-emitting element fixed to a substrate can be changed by the light path changing section to cause the light to enter the lens. This results in easily implementing the light-emitting element, and thus in being able to increase a degree of freedom in design.

Furthermore, in the present technology, for example, the connector body may be made of a light-transmissive material, and may integrally include the lens. In this case, the accuracy in positioning the lens with respect to connector body can be improved.

Moreover, in the present technology, the connector body may include a plurality of the lenses. Such a configuration of the connector body including a plurality of the lenses makes it possible to easily perform a multichannel communication.

Further, in the present technology, for example, the connector body may include a concave light exit portion, and the lens may be situated in a bottom portion of the light exit portion. When the lens is situated in the bottom portion of the light exit portion, as described above, this makes it possible to prevent the surface of the lens from unintendedly coming into contact with, for example, a counterpart connector and from being damaged.

Further, in the present technology, for example, on a side of a front face of the connector body, the connector body may integrally include a convex or concave position regulator used to align the optical connector with a connector to which the optical connector is connected. This makes it possible to easily perform an optical-axis alignment with a counterpart connector.

Furthermore, in the present technology, for example, the light emitter may be further included. Such a configuration of including the light emitter makes it possible to omit mounting of the light emitter.

Further, another concept of the present technology provides an optical cable that includes an optical connector that serves as a plug, the optical connector including a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.

Further, another concept of the present technology provides an electronic apparatus that includes an optical connector that serves as a receptacle, the optical connector including a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.

### BRIEF DESCRIPTION OF DRAWINGS

FIG. 1 illustrates a general description of an optical coupling connector, and is a diagram for describing the occurrence of a coupling loss in optical power due to a deviation with respect to an optical axis.

FIG. 2 is a diagram for describing a coupling loss in optical power due to a deviation with respect to an optical axis when light of which a power distribution is a normal distribution is used.

FIG. 3 illustrates an example in which a power distribution of output light from a light source is a normal distribution.

FIG. 4 illustrates an example of a structure of a VCSEL.

FIG. 5 is a diagram for explaining that a peak portion of a power distribution of output light from the VCSEL has a shape of a single ring.

FIG. 6 is a diagram for describing a coupling loss in optical power due to a deviation with respect to an optical axis when the peak portion of the power distribution has a shape of a single ring.

FIG. 7 illustrates an example of a configuration of an optical coupling connector according to the present technology.

FIG. 8 is a diagram for explaining that, in the example of the configuration of the present technology, a lens on the transmission side is not a normal spherical lens, but includes a first lens portion and a second lens portion.

FIG. 9 is a graph of a result of simulating the efficiency in coupling of light input to an optical fiber on the reception side.

FIG. 10 illustrates examples of configurations of an electronic apparatus and optical cables according to embodiments.

FIG. 11 is a perspective view illustrating examples of configurations of a transmission-side optical connector and a reception-side optical connector that are included in an optical coupling connector.

FIG. 12 is a perspective view illustrating the examples of the configurations of the transmission-side optical connector and the reception-side optical connector that are included in the optical coupling connector.

FIG. 13 is a set of cross-sectional views respectively illustrating the example of the configuration of the transmission-side optical connector and the example of the configuration of the reception-side optical connector.

FIG. 14 is a cross-sectional view illustrating an example of a state in which the transmission-side optical connector and the reception-side optical connector are connected to each other.

FIG. 15 is a set of cross-sectional views respectively illustrating another example of the configuration of the transmission-side optical connector and another example of the configuration of the reception-side optical connector.

FIG. 16 is a cross-sectional view illustrating a transmission-side optical connector of another configuration example 1.

FIG. 17 is a cross-sectional view illustrating a transmission-side optical connector of another configuration example 2.

FIG. 18 is a cross-sectional view illustrating a transmission-side optical connector of another configuration example 3.

FIG. 19 is a cross-sectional view illustrating a transmission-side optical connector of another configuration example 4.

FIG. 20 is a set of cross-sectional views each illustrating a transmission-side optical connector of another configuration example 5.

FIG. 21 illustrates an example in which a power distribution of output light from a light source has a shape of two rings.

### MODE(S) FOR CARRYING OUT THE INVENTION

Embodiments for carrying out the present technology (hereinafter referred to as “embodiments”) will now be described below. Note that the description is made in the following order.

### 1. Embodiments

### 2. Modifications

<1. Embodiments>

[Basic Description of Present Technology]

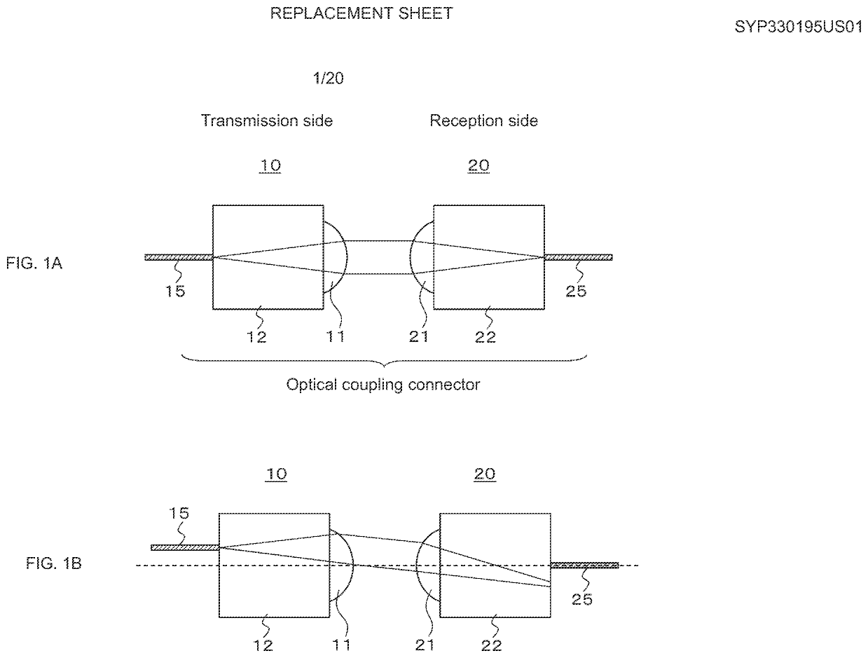

First, a technology related to the present technology is described. (a) of FIG. 1 illustrates a general description of an optical connector using an optical coupling system (hereinafter referred to as an “optical coupling connector”). The optical coupling connector includes a transmission-side optical connector 10 and a reception-side optical connector 20.

The transmission-side optical connector 10 includes a connector body 12 that includes a lens 11. The reception-side optical connector 20 includes a connector body 22 that includes a lens 21. When the transmission-side optical connector 10 and the reception-side optical connector 20 are connected to each other, the lens 11 and the lens 21 face each other, and optical axes of the lenses 11 and 21 coincide, as illustrated in the figure.

On the transmission side, an optical fiber 15 is provided to the connector body 12 such that an exit end of the optical fiber 15 is situated at a focal point on the optical axis of the lens 11. Further, on the reception side, an optical fiber 25 is provided to the connector body 22 such that an entrance end of the optical fiber 25 is situated at a focal point on the optical axis of the lens 21.

Light exiting the optical fiber 15 on the transmission side enters the lens 11 through the connector body 12. The light is formed into collimated light, and the collimated light exits the lens 11. The light is formed into collimated light, as described above, the collimated light enters the lens 21 to be collected by the lens 21, and the collimated light enters the entrance end of the optical fiber 25 on the reception side through the connector body 22. Accordingly, light (an optical signal) is transmitted from the optical fiber 15 on the transmission side to the optical fiber 25 on the reception side.

Here, when the position of the optical fiber 15 on the transmission side is shifted, as illustrated in (b) of FIG. 1, a light collecting point on the reception side is also shifted. This may result in a coupling loss in optical power. The light collecting point on the reception side is shifted since light that is supposed to be collimated by the lens 11 is bent, does not become parallel to the optical axis, and is obliquely input to the lens 21 on the reception side. Consequently, there will be great demands for the accuracy of a component if a fiber, such as a single-mode fiber, that has a very small core diameter of about 8 μmφ is used, in order to align optical axes of components. This results in an increase in costs.

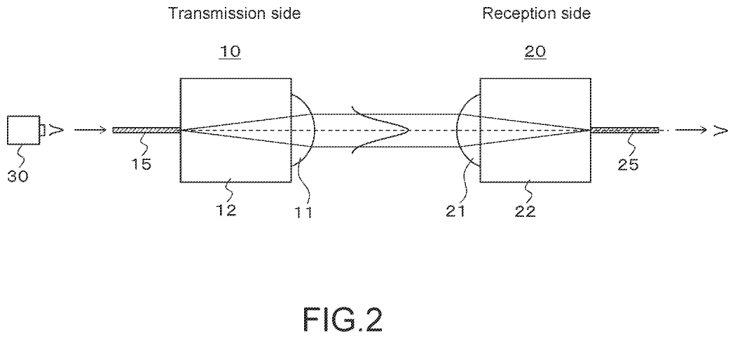

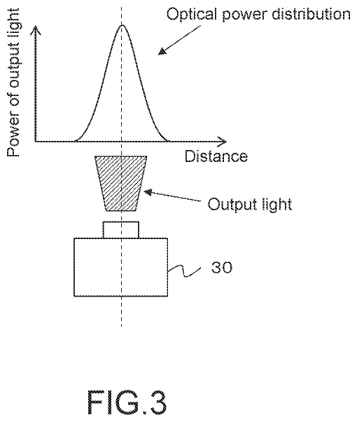

When light output from a light source 30 has a power distribution that is a normal distribution generally used for a long-distance transmission, as illustrated in FIGS. 2 and 3, the position of lost light that will not be successfully received by the reception side when the position of a component on the transmission side is shifted, is gradually moved from a low-power portion corresponding to a tail of the normal distribution to a high-power portion in the normal distribution. Thus, some positional deviation only results in a small loss, and thus in a low impact.

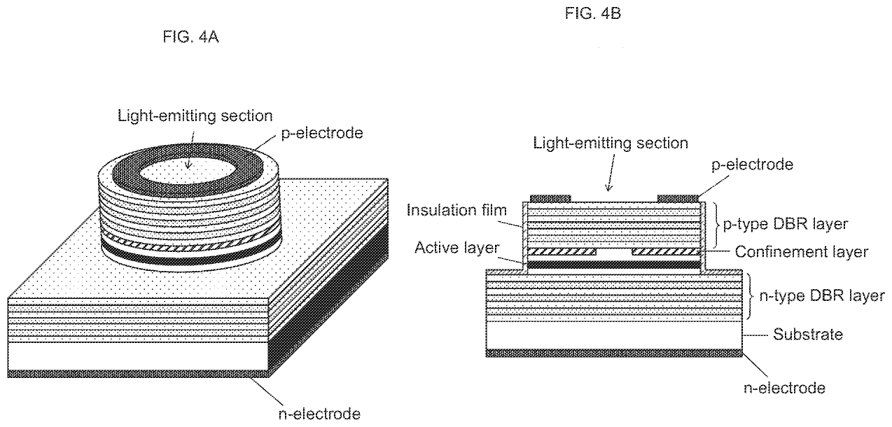

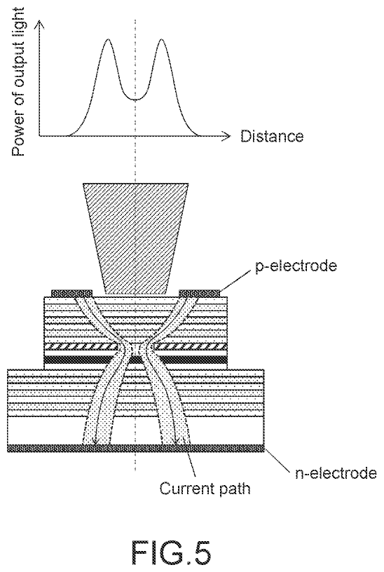

However, in the case of a surface-emitting laser such as a vertical-cavity surface-emitting laser (VCSEL) illustrated in (a) and (b) of FIG. 4, light is output from a light-emitting section by passing current from a p-electrode to an n-electrode. In this case, a distribution of current is uneven, as illustrated in FIG. 5, since the p-electrode generally has a ring shape. Consequently, a power distribution of light also has a peak portion of power at a position close to the ring electrode.

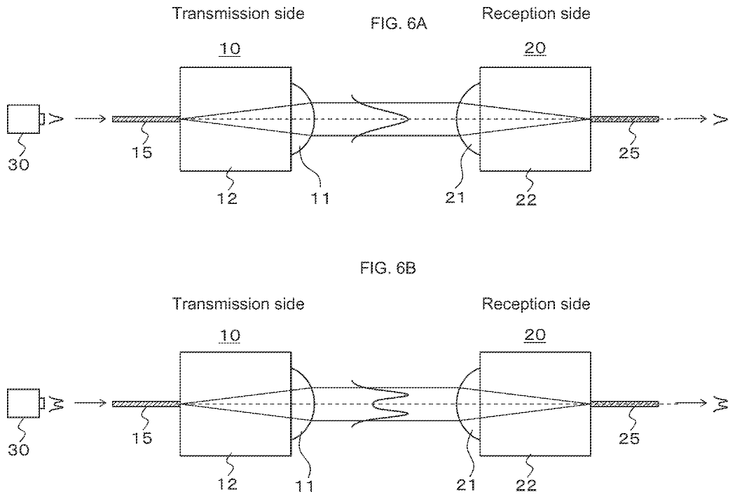

Here, when a power distribution of the light source 30 has a power peak at both ends of the distribution, as illustrated in (b) of FIG. 6, a peak power portion is not successfully received by the reception side due to a small amount of a positional deviation, compared to the case of a normal distribution illustrated in (a) of FIG. 6. This may result in a significant loss.

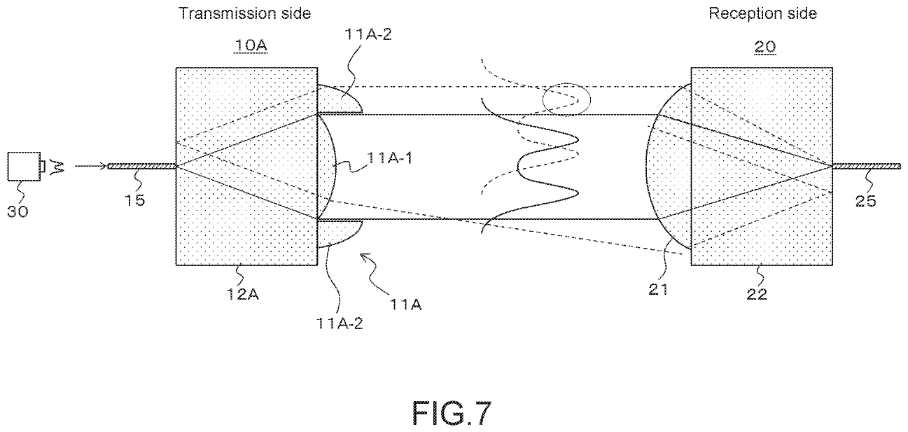

FIG. 7 illustrates an example of a configuration of an optical coupling connector according to the present technology. The optical coupling connector includes a transmission-side optical connector 10A and a reception-side optical connector 20. As in the case of the example illustrated in FIG. 1, the reception-side optical connector 20 includes the connector body 22 that includes the lens 21.

The transmission-side optical connector 10A includes a connector body 12A that includes a lens 11A. The lens 11A includes a first lens portion 11A-1 that is situated in a center portion of the lens 11A, and a ring-shaped second lens portion 11A-2 that is situated around an outer circumference of the first lens portion 11A-1.

When a portion of input light of which an optical axis deviates from an optical axis of the lens 11A is input to the second lens portion 11A-2, the second lens portion 11A-2 changes a light path of the portion of the input light such that the light path is oriented toward a direction of the optical axis of the lens 11A. The second lens portion 11A-2 has a shape corresponding to a shape of a peak portion of a power distribution of the input light. In the example of FIG. 7, a peak portion of a power distribution of input light coming from the light source 30 through the optical fiber 15 has a shape of a single ring. Thus, the second lens portion 11A-2 has a shape of a single ring. The lens 11A is designed such that, when light of which a power distribution has a peak portion having a shape of a single ring is input to the lens 11A, the peak portion is formed into perfect collimated light by the second lens portion 11A-2.

When an optical axis of the optical fiber 15 on the transmission side coincides the optical axis of the lens 11A, all of the light exiting the optical fiber 15 enters the first lens portion 11A-1 of the lens 11A through the connector body 12A, the light is formed into collimated light by the first lens portion 11A-1, and the collimated light exits the first lens portion 11A-1, as indicated by a solid line. Further, the collimated light obtained by the formation, as described above, enters the lens 21 on the reception side to be collected by the lens 21, and enters the entrance end of the optical fiber 25 through the connector body 22.

On the other hand, when the optical axis of the optical fiber 15 on the transmission side deviates from the optical axis of the lens 11A, as indicated by a dashed line, the light exiting the optical fiber 15 enters the first lens portion 11A-1 and the second lens portion 11A-2 of the lens 11A through the connector body 12A. Light exiting the first lens portion 11A-1 is not light extending along the optical axis of the lens 11A, and is obliquely input to the lens 21 on the reception side. Thus, a light collecting point for the light exiting the first lens portion 11A-1 is shifted downward, compared to the case in which the optical axis of the optical fiber 15 on the transmission side coincides the optical axis of the lens 11A.

Further, light exiting the second lens portion 11A-2 is light extending along the optical axis of the lens 11A, that is, collimated light. Thus, the light exiting the second lens portion 11A-2 enters the lens 21 on the reception side in parallel with the optical axis of the lens 21. Thus, the light enters the entrance end of the optical fiber 25 through the connector body 22. Therefore, a high-power portion of the input light can be received by the reception side even if the optical axis of the optical fiber 15 on the transmission side deviates from the optical axis of the lens 11A. This results in a reduction in loss. However, with respect to light of a power peak portion situated opposite to a direction in which the optical axis of the optical fiber 15 deviates from the optical axis of the lens 11A, the light deviates from the entrance end of the optical fiber 25, as in the case of (b) of FIG. 1.

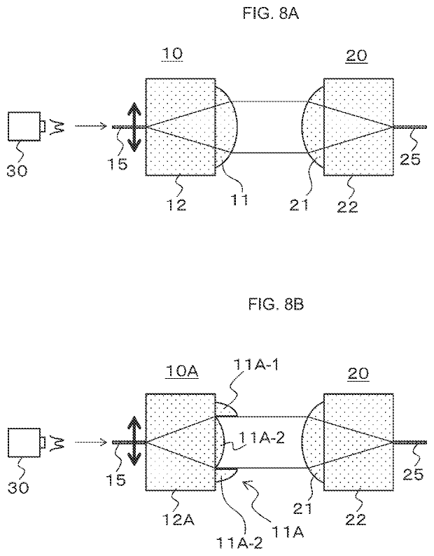

(a) of FIG. 8 illustrates an example of a configuration in which the lens 11 on the transmission side is a normal spherical lens (refer to FIG. 1). Further, (b) of FIG. 8 illustrates an example of a configuration according to the present technology, where the lens 11A on the transmission side includes the first lens portion 11A-1 and the second lens portion 11A-2 (refer to FIG. 7).

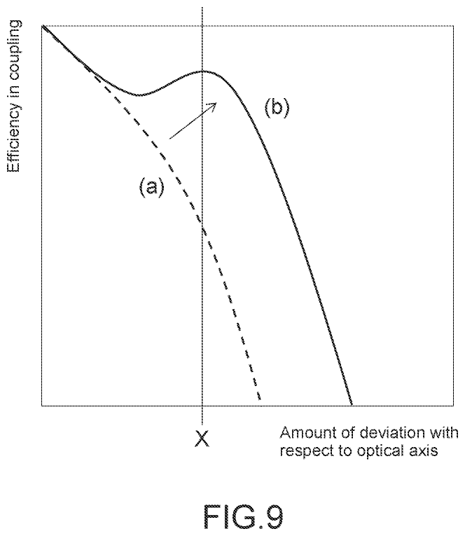

FIG. 9 is a graph of a result of simulating the efficiency in coupling of light input to an optical fiber on the reception side. The horizontal axis represents an amount of an axial deviation, that is, an amount of a deviation when a light source is shifted in a direction vertical to the optical axis, and the vertical axis represents the efficiency in coupling of light on the reception side. A dashed line (a) indicates a relationship between an amount of an axial deviation and the efficiency in coupling in the example of the configuration illustrated in (a) of FIG. 8. In this case, an amount of a deviation due to a deviation with respect to an optical axis results in loss with no change.

Further, a solid line (b) indicates a relationship between an amount of an axial deviation and the efficiency in coupling in the example of the configuration according to the present technology illustrated in (b) of FIG. 8. In this case, light of a peak portion of a power distribution can be transmitted to a fiber on the reception side even if there is a deviation with respect to an optical axis. This results in a reduction in loss, compared to the case of the solid line (a). Here, an upward sloping portion of the line reaches a peak at a point X at which a certain degree of deviation occurs, since the second lens portion 11A-2 has a shape that makes it possible to most successfully collimate light of a peak portion of a power distribution at the deviation point X.

[Examples of Configurations of Electronic Apparatus and Optical Cable]

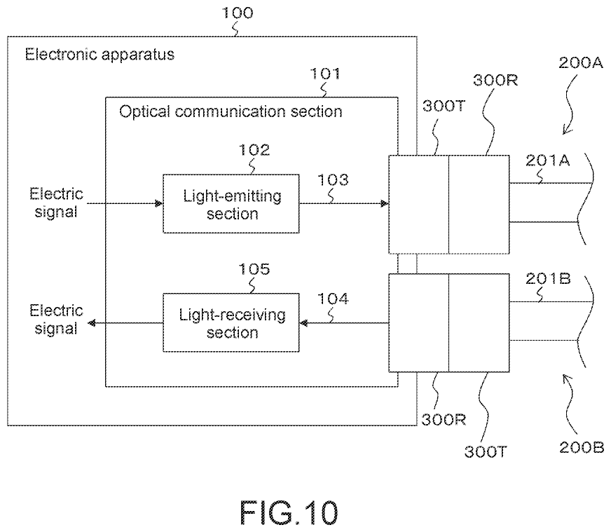

FIG. 10 illustrates examples of configurations of an electronic apparatus 100 and optical cables 200A and 200B according to embodiments. The electronic apparatus 100 includes an optical communication section 101. The optical communication section 101 includes a light-emitting section 102, an optical transmission line 103, a transmission-side optical connector 300T serving as a receptacle, a reception-side optical connector 300R serving as a receptacle, an optical transmission line 104, and a light-receiving section 105. The optical transmission line 103 and the optical transmission line 104 can each be implemented by an optical fiber.

The light-emitting section 102 includes a laser element such as a vertical-cavity surface-emitting laser (VCSEL), or a light-emitting element such as a light-emitting diode (LED). The light-emitting section 102 converts, into an optical signal, an electric signal (a transmission signal) generated by a transmission circuit (not illustrated) of the electronic apparatus 100. The optical signal emitted by the light-emitting section 102 is transmitted to the transmission-side optical connector 300T through the optical transmission line 103. Here, an optical transmitter includes the light-emitting section 102, the optical transmission line 103, and the transmission-side optical connector 300T.

An optical signal received by the reception-side optical connector 300R is transmitted to the light-receiving section 105 through the optical transmission line 104. The light-receiving section 105 includes a light-receiving element such as a photodiode. The light-receiving section 105 converts, into an electric signal (a reception signal), the optical signal transmitted by the reception-side optical connector 300R, and supplies the electric signal to a reception circuit (not illustrated) of the electronic apparatus 100. Here, an optical receiver includes the reception-side optical connector 300R, the optical transmission line 104, and the light-receiving section 105.

The optical cable 200A includes the reception-side optical connector 300R serving as a plug, and a cable body 201A. The optical cable 200A carries an optical signal coming from the electronic apparatus 100 to another electronic apparatus. The cable body 201A can be implemented by an optical fiber.

One end of the optical cable 200A is connected to the transmission-side optical connector 300T of the electronic apparatus 100 through the reception-side optical connector 300R, and the other end is connected to another electronic apparatus (not illustrated). In this case, an optical coupling connector includes the transmission-side optical connector 300T and the reception-side optical connector 300R being connected to each other.

The optical cable 200B includes the transmission-side optical connector 300T serving as a plug, and a cable body 201B. The optical cable 200B carries an optical signal coming from another electronic apparatus to the electronic apparatus 100. The cable body 201B can be implemented by an optical fiber.

One end of the optical cable 200B is connected to the reception-side optical connector 300R of the electronic apparatus 100 through the transmission-side optical connector 300T, and the other end is connected to another electronic apparatus (not illustrated). In this case, an optical coupling connector includes the transmission-side optical connector 300T and the reception-side optical connector 300R being connected to each other.

Note that examples of the electronic apparatus 100 may include mobile electronic apparatuses such as a cellular phone, a smartphone, a personal handyphone system (PHS), a PDA, a tablet PC, a laptop computer, a video camera, an IC recorder, a portable media player, an electronic organizer, an electronic dictionary, a calculator, and a portable game machine; and other electronic apparatuses such as a desktop computer, a display apparatus, a television set, a radio set, a video recorder, a printer, a car navigation system, a game machine, a router, a hub, and an optical network unit (ONU). Further, the electronic apparatus 100 may be a portion of or the entirety of an electrical appliance, or may be a portion of or the entirety of a vehicle described later. Examples of the electrical appliance include a refrigerator, a washing machine, a clock, an intercom, an air conditioner, a humidifier, an air cleaner, an illuminator, and a cooking appliance.

[Example of Configuration of Optical Connector]

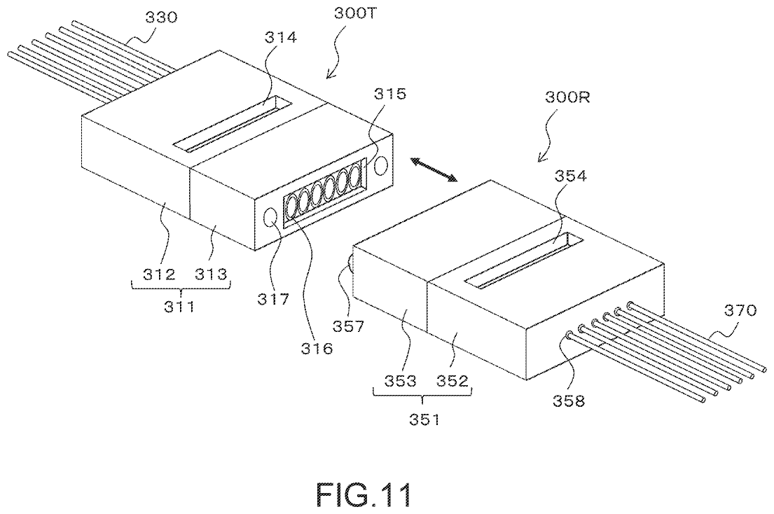

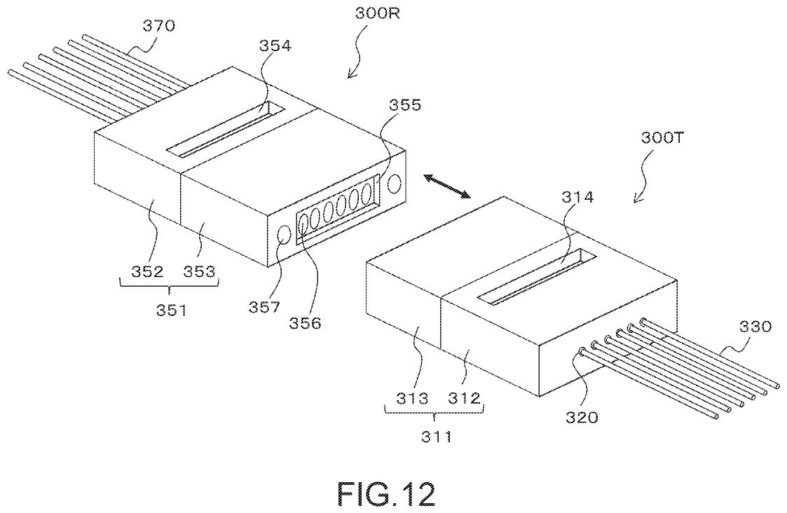

FIG. 11 is a perspective view illustrating examples of the transmission-side optical connector 300T and the reception-side optical connector 300R that are included in an optical coupling connector. FIG. 12 is also a perspective view illustrating the examples of the transmission-side optical connector 300T and the reception-side optical connector 300R, as viewed from a direction opposite to a direction from which the transmission-side optical connector 300T and the reception-side optical connector 300R are viewed in FIG. 11. The illustrated example meets a parallel transmission of optical signals of a plurality of channels. Note that the configuration that meets a parallel transmission of optical signals of a plurality of channels is illustrated here, but it is also possible to provide a configuration that meets a transmission of an optical signal of a channel, although a detailed description thereof is omitted.

The transmission-side optical connector 300T includes a connector body 311 of which an appearance has a shape of a substantially rectangular parallelepiped. The connector body 311 includes a first optical section 312 and a second optical section 313 that are connected to each other. As described above, the connector body 311 includes the first and second optical sections 312 and 313, and this makes it possible to easily perform production.

A plurality of horizontally arranged optical fibers 330 respectively corresponding to channels is connected on the side of a rear face of the first optical section 312. In this case, ends of the respective optical fibers 330 are respectively inserted into optical fiber inserting holes 320 to fix the optical fibers 330. Here, the optical fiber 330 is included in a light emitter. Further, an adhesive injection hole 314 that includes a rectangular opening is formed on the side of an upper face of the first optical section 312. An adhesive used to fix the optical fiber 330 to the first optical section 312 is injected through the adhesive injection hole 314.

A concave light exit portion (a light transmission space) 315 that includes a rectangular opening is formed on the side of a front face of the second optical section 313, and a plurality of horizontally arranged lenses 316 respectively corresponding to channels is formed in a bottom portion of the light exit portion 315. This prevents the surface of the lens 316 from unintendedly coming into contact with, for example, a counterpart connector and from being damaged.

Here, as in the case of the lens 11A of FIG. 7 described above, the lens 316 includes a first lens portion that is situated in a center portion of the lens 316, and a ring-shaped second lens portion that is situated around an outer circumference of the first lens portion.

When a portion of input light of which an optical axis deviates from an optical axis of the lens 316 is input to the second lens portion, the second lens portion changes a light path of the portion of the input light such that the light path is oriented toward a direction of the optical axis of the lens 316. The second lens portion has a shape corresponding to a shape of a peak portion of a power distribution of the input light. In this case, a peak portion of a power distribution of input light has a shape of a single ring. Thus, the second lens portion has a shape of a single ring.

Further, a convex or concave position regulator 317 used to align the transmission-side optical connector 300T with the reception-side optical connector 300R is integrally formed on the side of the front face of the second optical section 313, where the position regulator 317 is concave in the illustrated example. This makes it possible to easily perform an optical-axis alignment when the transmission-side optical connector 300T is connected to the reception-side optical connector 300R.

The reception-side optical connector 300R includes a connector body 351 of which an appearance has a shape of a substantially rectangular parallelepiped. The connector body 351 includes a first optical section 352 and a second optical section 353 that are connected to each other. As described above, the connector body 351 includes the first and second optical sections 352 and 353, and this makes it possible to easily perform production.

A plurality of horizontally arranged optical fibers 370 respectively corresponding to channels is connected on the side of a rear face of the first optical section 352. In this case, ends of the respective optical fibers 370 are respectively inserted into optical fiber inserting holes 358 to fix the optical fibers 370. Further, an adhesive injection hole 354 that includes a rectangular opening is formed on the side of an upper face of the first optical section 352. An adhesive used to fix the optical fiber 370 to the first optical section 352 is injected through the adhesive injection hole 354.

A concave light entrance portion (a light transmission space) 355 that includes a rectangular opening is formed on the side of a front face of the second optical section 353, and a plurality of horizontally arranged lenses 356 respectively corresponding to channels is formed in a bottom portion of the light entrance portion 355. This prevents the surface of the lens 356 from unintendedly coming into contact with, for example, a counterpart connector and from being damaged.

Further, a concave or convex position regulator 357 used to align the reception-side optical connector 300R with the transmission-side optical connector 300T is integrally formed on the side of the front face of the second optical section 353, where the position regulator 357 is convex in the illustrated example. This makes it possible to easily perform an optical-axis alignment when the reception-side optical connector 300R is connected to the transmission-side optical connector 300T. Note that the position regulator 357 is not limited to being formed integrally with the connector body 351, and the formation may be performed using a pin or by another method.

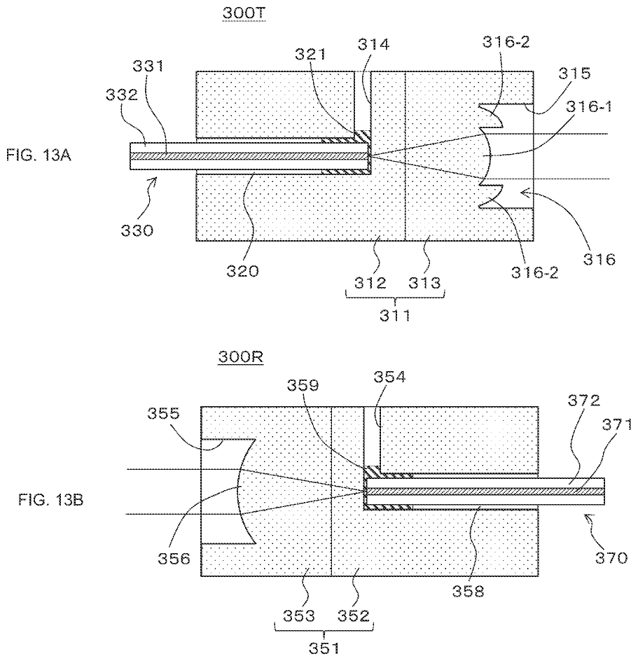

(a) of FIG. 13 is a cross-sectional view illustrating the example of the transmission-side optical connector 300T. An illustration of the position regulator 317 (refer to FIG. 11) is omitted in the illustrated example. The transmission-side optical connector 300T is further described with reference to (a) of FIG. 13.

The transmission-side optical connector 300T includes the connector body 311 configured by the first optical section 312 and the second optical section 313 being connected to each other.

The second optical section 313 is made of, for example, a light-transmissive material such as synthetic resin or glass, or a material, such as silicon, through which a specific wavelength is transmitted. The connector body 311 is configured by the second optical section 313 being connected to the first optical section 312. It is favorable that the second optical section 313 be made of the same material as the first optical section 312 since a deviation of a light path due to the two optical sections being distorted when there is a thermal change, can be prevented by the two optical sections having the same coefficient of thermal expansion. However, the second optical section 313 may be made of a material different from the material of the first optical section 312.

The concave light exit portion (the light transmission space) 315 is formed on the side of the front face of the second optical section 313. Further, the plurality of horizontally arranged lenses 316 respectively corresponding to channels is formed integrally with the second optical section 313 to be situated in the bottom portion of the light exit portion 315. Accordingly, the accuracy in positioning the lens 316 with respect to a core 331 of the optical fiber 330 placed in the first optical section 312 can be simultaneously improved for a plurality of channels. The core 331 will be described later.

Here, the lens 316 includes a first lens portion 316-1 that is situated in a center portion of the lens 316, and a ring-shaped second lens portion 316-2 that is situated around an outer circumference of the first lens portion 316-1.

When a portion of input light of which an optical axis deviates from the optical axis of the lens 316 is input to the second lens portion 316-2, the second lens portion 316-2 changes a light path of the portion of the input light such that the light path is oriented toward a direction of the optical axis of the lens 316. The second lens portion 316-2 has a shape corresponding to a shape of a peak portion of a power distribution of the input light. In this case, a peak portion of a power distribution of input light has a shape of a single ring. Thus, the second lens portion 316-2 has a shape of a single ring.

The first optical section 312 is made of, for example, a light-transmissive material such as synthetic resin or glass, or a material, such as silicon, through which a specific wavelength is transmitted, and the first optical section 312 is in the form of a ferrule. Accordingly, a multichannel communication can be easily performed just by inserting the optical fiber 330 into the ferrule.

A plurality of horizontally arranged optical fiber inserting holes 320 each extending forward from the side of the rear face of the first optical section 312, is provided to the first optical section 312. The optical fiber 330 has a two-layer structure including the core 331 and cladding 332, the core 331 being a center portion that serves as a light path, the cladding 332 covering a peripheral surface of the core 331.

The optical fiber inserting hole 320 for each channel is formed such that the core 331 of the optical fiber 330 inserted into the optical fiber inserting hole 320 coincides the optical axis of a corresponding lens 316. Further, the optical fiber inserting hole 320 for each channel is formed such that a bottom of the optical fiber inserting hole 320, that is, a contact portion of the optical fiber inserting hole 320 coincides a focal point of the first lens portion 316-1 of the lens 316, the contact portion of the optical fiber inserting hole 320 being a portion with which the end (an exit end) of the optical fiber 330 is brought into contact when the optical fiber 330 is inserted into the optical fiber inserting hole 320.

Further, the adhesive injection hole 314 extending downward from the side of the upper face of the first optical section 312 is formed in the first optical section 312 such that the adhesive injection hole 314 communicates with a portion situated around the bottoms of the plurality of horizontally arranged optical fiber inserting holes 320. After the optical fiber 330 is inserted into the optical fiber inserting hole 320, an adhesive 321 is injected into a portion situated around the optical fiber 330 through the adhesive injection hole 314. This results in fixing the optical fiber 330 to the first optical section 312.

Here, if there is an airspace between the end of the optical fiber 330 and the bottom of the optical fiber inserting hole 320, light exiting the optical fiber 330 will be easily reflected off the bottom of the optical fiber inserting hole 320, and this will result in a reduction in signal quality. Thus, it is favorable that the adhesive 321 be a light-transmissive material and be injected into a space situated between the end of the optical fiber 330 and the bottom of the optical fiber inserting hole 320. This makes it possible to reduce reflection.

As described above, the connector body 311 is configured by the first optical section 312 and the second optical section 313 being connected to each other. For example, a method including newly forming a concave portion such as a boss in one of the two optical sections, newly forming a convex portion in the other optical section, and then performing fitting; or a method including aligning optical axes of lenses using, for example, an image processing system, and then performing bonding and fixation may be adopted as a method for the connection described above.

In the transmission-side optical connector 300T, the lens 316 operates to perform formation with respect to light exiting the optical fiber 330 and to cause light obtained by the formation to exit the lens 316. Accordingly, formation is performed by the lens 316 with respect to light exiting the exit end of the optical fiber 330, and light obtained by the formation exits the lens 316.

Here, when an optical axis of the optical fiber 330 coincides the optical axis of the lens 316, all of the light exiting the optical fiber 330 enters the first lens portion 316-1 of the lens 316, the light is formed into collimated light by the first lens portion 316-1, and the collimated light exits the first lens portion 316-1, as indicated by a solid line.

On the other hand, when the optical axis of the optical fiber 330 deviates from the optical axis of the lens 316, the light exiting the optical fiber 316 enters the first lens portion 316-1 and the second lens portion 316-2 of the lens 316. Then, light exiting the first lens portion 316-1 is not light extending along the optical axis of the lens 316, and travels obliquely, whereas light exiting the second lens portion 316-2 travels in the direction of the optical axis of the lens 316 (refer to the dashed line in FIG. 7).

(b) of FIG. 13 is a cross-sectional view illustrating the example of the reception-side optical connector 300R. An illustration of the position regulator 357 (refer to FIGS. 11 and 12) is omitted in the illustrated example. The reception-side optical connector 300R is further described with reference to (b) of FIG. 13.

The reception-side optical connector 300R includes the connector body 351 configured by the first optical section 352 and the second optical section 353 being connected to each other.

The second optical section 353 is made of, for example, a light-transmissive material such as synthetic resin or glass, or a material, such as silicon, through which a specific wavelength is transmitted. The connector body 351 is configured by the second optical section 353 being connected to the first optical section 352. It is favorable that the second optical section 353 be made of the same material as the first optical section 352 since a deviation of a light path due to the two optical sections being distorted when there is a thermal change, can be prevented by the two optical sections having the same coefficient of thermal expansion. However, the second optical section 353 may be made of a material different from the material of the first optical section 352.

The concave light entrance portion (the light transmission space) 355 is formed on the side of the front face of the second optical section 353. Further, the plurality of horizontally arranged lenses 356 respectively corresponding to channels is formed integrally with the second optical section 353 to be situated in the bottom portion of the light entrance portion 355. Accordingly, the accuracy in positioning the lens 356 with respect to a core 371 of the optical fiber 370 placed in the first optical section 352 can be simultaneously improved for a plurality of channels. The core 371 will be described later.

The first optical section 352 is made of, for example, a light-transmissive material such as synthetic resin or glass, or a material, such as silicon, through which a specific wavelength is transmitted, and the first optical section 352 is in the form of a ferrule. Accordingly, a multichannel communication can be easily performed just by inserting the optical fiber 370 into the ferrule.

A plurality of horizontally arranged optical fiber inserting holes 358 each extending forward from the side of the rear face of the first optical section 352, is provided to the first optical section 352. The optical fiber 370 has a two-layer structure including the core 371 and cladding 372, the core 371 being a center portion that serves as a light path, the cladding 372 covering a peripheral surface of the core 371.

The optical fiber inserting hole 358 for each channel is formed such that the core 371 of the optical fiber 370 inserted into the optical fiber inserting hole 358 coincides the optical axis of a corresponding lens 356. Further, the optical fiber inserting hole 358 for each channel is formed such that a bottom of the optical fiber inserting hole 358, that is, a contact portion of the optical fiber inserting hole 358 coincides a focal point of the lens 356, the contact portion of the optical fiber inserting hole 358 being a portion with which the end (an entrance end) of the optical fiber 370 is brought into contact when the optical fiber 370 is inserted into the optical fiber inserting hole 358.

Further, the adhesive injection hole 354 extending downward from the side of the upper face of the first optical section 352 is formed in the first optical section 352 such that the adhesive injection hole 354 communicates with a portion situated around the bottoms of the plurality of horizontally arranged optical fiber inserting holes 358. After the optical fiber 370 is inserted into the optical fiber inserting hole 358, an adhesive 359 is injected into a portion situated around the optical fiber 370 through the adhesive injection hole 354. This results in fixing the optical fiber 370 to the first optical section 352.

As described above, the connector body 351 is configured by the first optical section 352 and the second optical section 353 being connected to each other. For example, a method including newly forming a concave portion such as a boss in one of the two optical sections, newly forming a convex portion in the other optical section, and then performing fitting; or a method including aligning optical axes of lenses using, for example, an image processing system, and then performing bonding and fixation may be adopted as a method for the connection described above.

In the reception-side optical connector 300R, the lens 356 operates to collect entering light. In this case, the light coming from the transmission side enters the lens 356, and is collected by the lens 356. The collected light enters, with a specified NA, the entrance end of the optical fiber 370 serving as a light receiver. However, with respect to light obliquely input to the lens 356, a light collecting point is shifted.

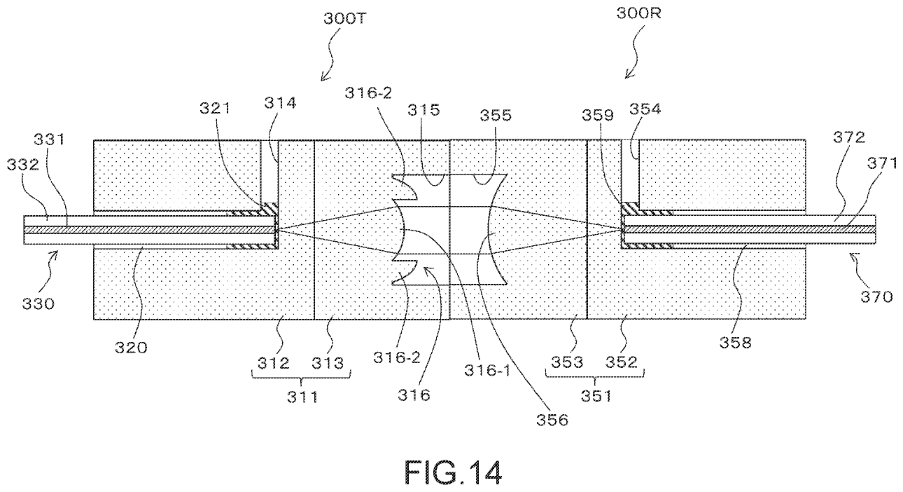

FIG. 14 illustrates a cross-sectional view of the transmission-side optical connector 300T and the reception-side optical connector 300R that are included in an optical coupling connector. The figure illustrates an example of a state in which the transmitting-side optical connector 300T and the reception-side optical connector 300R are connected to each other.

In the transmission-side optical connector 300T, light transmitted through the optical fiber 330 exits the exit end of the optical fiber 330 with a specified NA. The exiting light enters the lens 316, and formation is performed with respect to the light. Then, light obtained by the formation exits the lens 316 to be oriented toward the reception-side optical connector 300R.

Further, in the reception-side optical connector 300R, light exiting the transmitting-side optical connector 300T enters the lens 356 to be collected by the lens 356. Then, the collected light enters the entrance end of the optical fiber 370, and is transmitted through the optical fiber 370.

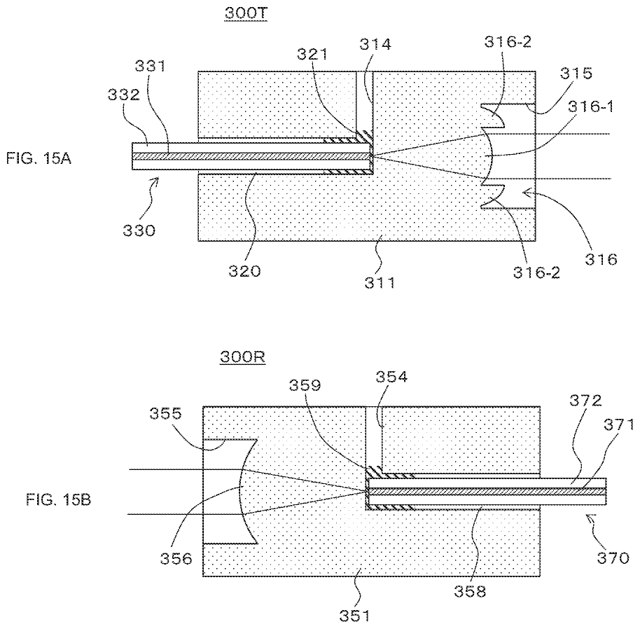

Note that the example in which the connector body 311 of the transmission-side optical connector 300T is configured by the first optical section 312 and the second optical section 313 being connected to each other, has been described above. However, the connector body 311 may include a single optical section, as illustrated in (a) of FIG. 15. Likewise, the example in which the connector body 351 of the reception-side optical connector 300R is configured by the first optical section 352 and the second optical section 353 being connected to each other, has been described above. However, the connector body 351 may include a single optical section, as illustrated in (b) of FIG. 15. In FIG. 15, a portion corresponding to a portion of FIG. 13 is denoted by the same reference numeral as the portion of FIG. 13.

In the optical coupling connector having the configuration described above, the lens 316 of the transmission-side optical connector 300T includes the circular first lens portion 316-1 situated in the center portion of the lens 316, and the ring-shaped second lens portion 316-2 situated around the outer circumference of the first lens portion 316-1. When a portion of input light of which an optical axis deviates from the optical axis of the lens 316 is input to the second lens portion 316-2, the second lens portion 316-2 changes a light path of the portion of the input light such that the light path is oriented toward the direction of the optical axis of the lens 316. This makes it possible to reduce a coupling loss in optical power on the reception side that occurs due to an optical axis of input light deviating from the optical axis of the lens 316.

Note that the effects described herein are not limitative but are merely illustrative, and additional effects may be provided.

[Other Examples of Configuration of Transmission-Side Optical Connector]

In addition to the transmission-side optical connector 300T described above (refer to Figs. (a) of 13 and (a) of FIG. 15), various configurations may be adopted as the configuration of the transmission-side optical connector.

“Another Configuration Example 1”

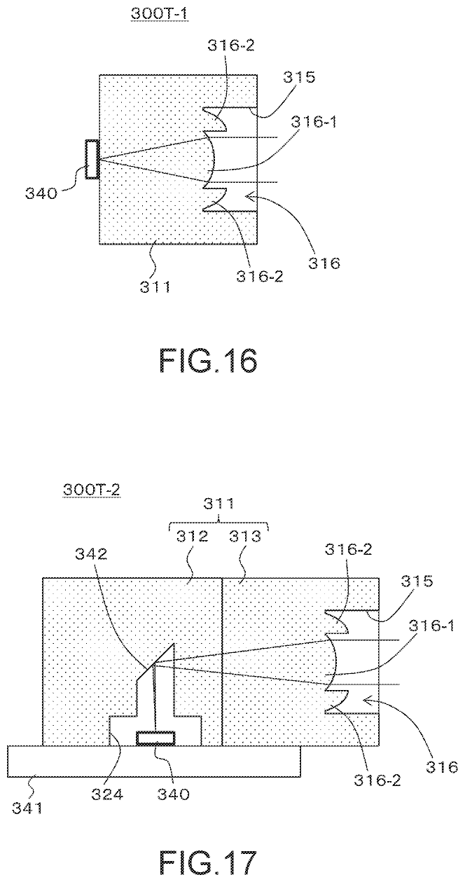

FIG. 16 is a cross-sectional view illustrating a transmission-side optical connector 300T-1 of another configuration example 1. In FIG. 16, a portion corresponding to a portion of (a) of FIG. 13 is denoted by the same reference numeral as the portion of (a) of FIG. 13, and a detailed description thereof is omitted as appropriate. In the transmission-side optical connector 300T-1, the connector body 311 includes a single optical section (corresponding to the second optical section 313 of (a) of FIG. 13). Further, a light emitter fixed to the connector body 311 is not the optical fiber 330, but a light-emitting element 340 such as a vertical-cavity surface-emitting laser (VCSEL).

In this case, a plurality of light-emitting elements 340 horizontally arranged correspondingly to the lenses 316 for the respective channels is fixed on the side of the rear face of the connector body 311. Further, in this case, the light-emitting element 340 for each channel is fixed such that an exit portion of the light-emitting element 340 coincides the optical axis of a corresponding lens 316. Furthermore, in this case, the thickness and the like in an optical-axis direction of the connector body 311 are set such that the exit portion of the light-emitting element 340 for each channel coincides the focal point of the corresponding lens 316.

As in the case of the transmission-side optical connector 300T of (a) of FIG. 13, in the transmission-side optical connector 300T-1, formation is performed by the lens 316 with respect to light exiting the exit portion of the light-emitting element 340 with a specified NA, and light obtained by the formation exits the lens 316.

When the light-emitting element 340 is fixed to the connector body 311, as described above, this results in there being no need for an optical fiber upon transmitting an optical signal coming from the light-emitting element 340. This makes it possible to reduce costs.

“Another Configuration Example 2”

FIG. 17 is a cross-sectional view illustrating a transmission-side optical connector 300T-2 of another configuration example 2. In FIG. 17, a portion corresponding to a portion of (a) of FIG. 13 or FIG. 16 is denoted by the same reference numeral as the portion of (a) of FIG. 13 or FIG. 16, and a detailed description thereof is omitted as appropriate. In the transmission-side optical connector 300T-2, a substrate 341 on which the light-emitting element 340 is placed is fixed on the side of a lower face of the connector body 311. In this case, a plurality of light-emitting elements 340 horizontally arranged correspondingly to the lenses 316 for the respective channels is placed on the substrate 341.

A light-emitting-element arranging hole 324 extending upward from the side of a lower face of the first optical section 312 is formed in the first optical section 312. Further, in order to change a path of light coming from the light-emitting element 340 for each channel, such that the light path is oriented toward a direction of a corresponding lens 316, a bottom portion of the light-emitting-element arranging hole 324 includes an inclined surface, and a mirror 342 is arranged on the inclined surface. Note that the mirror 342 is not limited to being separately generated and being fixed on the inclined surface, and the mirror 342 may be formed on the inclined surface by, for example, vapor deposition.

Here, the position of the substrate 341 is adjusted and the substrate 341 is fixed, such that the exit portion of the light-emitting element 340 for each channel coincides the optical axis of a corresponding lens 316. Further, in this case, the position at which the lens 316 is formed, the position at which the light-emitting-element arranging hole 324 is formed, the length of the light-emitting-element arranging hole 324, and the like are set such that the exit portion of the light-emitting element 340 for each channel coincides the focal point of the corresponding lens 316.

In the transmission-side optical connector 300T-2, a path of light exiting the exit portion of the light-emitting element 340 with a specified NA is changed by the mirror 342. Then, as in the case of the transmission-side optical connector 300T of (a) of FIG. 13, formation is performed by the lens 316 with respect to the light, and light obtained by the formation exits the lens 316.

When the substrate 341 on which the light-emitting element 340 is placed is fixed to the connector body 311, as described above, this results in there being no need for an optical fiber upon transmitting an optical signal coming from the light-emitting element 340. This makes it possible to reduce costs. Further, a path of light coming from the light-emitting element 340 placed on the substrate 341 is changed by the mirror 342 to cause the light to enter the lens 316. This results in easily performing implementation, and thus in being able to increase a degree of freedom in design.

In general, it is difficult to perform implementation when the light-emitting element 340 is mounted on the connector body 311 that is a lens component, as in the case of FIG. 16. However, when the mirror 342 is provided, as illustrated in FIG. 17, the light-emitting element 340 can be placed on the substrate 341. This results in being able to increase a degree of freedom in design, such as an easy implementation.

“Another Configuration Example 3”

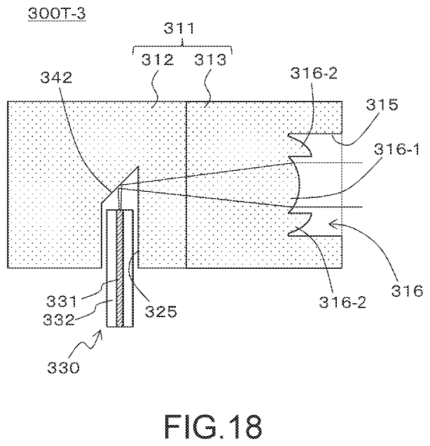

FIG. 18 is a cross-sectional view illustrating a transmission-side optical connector 300T-3 of another configuration example 3. In FIG. 18, a portion corresponding to a portion of (a) of FIG. 13 or FIG. 17 is denoted by the same reference numeral as the portion of (a) of FIG. 13 or FIG. 17, and a detailed description thereof is omitted as appropriate. In the transmission-side optical connector 300T-3, a plurality of optical fiber inserting holes 325 horizontally arranged correspondingly to the lenses 316 for the respective channels is formed in the first optical section 312, each optical fiber inserting hole 325 extending upward from the side of the lower face of the first optical section 312.

In order to change a path of light coming from the optical fiber 330 inserted into the optical fiber inserting hole 325, such that the light path is oriented toward a direction of a corresponding lens 316, a bottom portion of each optical fiber inserting hole 325 includes an inclined surface, and the mirror 342 is arranged on the inclined surface. Further, each optical fiber inserting hole 325 is formed such that the core 331 of the optical fiber 330 inserted into the optical fiber inserting hole 325 coincides the optical axis of the corresponding lens 316.

The optical fiber 330 for each channel is inserted into a corresponding optical fiber inserting hole 325, and, for example, an adhesive (not illustrated) is injected into a portion situated around the optical fiber 330. This results in fixing the optical fiber 330. In this case, the position of inserting the optical fiber 330 is set such that the end (the exit end) of the optical fiber 330 coincides the focal point of a corresponding lens 316, that is, such that the end (the exit end) of the optical fiber 330 is situated at a certain distance from the mirror 342.

In the transmission-side optical connector 300T-3, a path of light exiting the exit end of the optical fiber 330 with a specified NA is changed by the mirror 342. Then, as in the case of the transmission-side optical connector 300T of (a) of FIG. 13, formation is performed by the lens 316 with respect to the light, and light obtained by the formation exits the lens 316.

In this configuration example, the first optical section 312 is in the form of a ferrule. This makes it possible to easily align the optical axes of the optical fiber 330 and the lens 316. Further, in this configuration example, a path of light coming from the optical fiber 330 is changed by the mirror 342. This results in easily performing implementation, and thus in being able to increase a degree of freedom in design.

“Another Configuration Example 4”

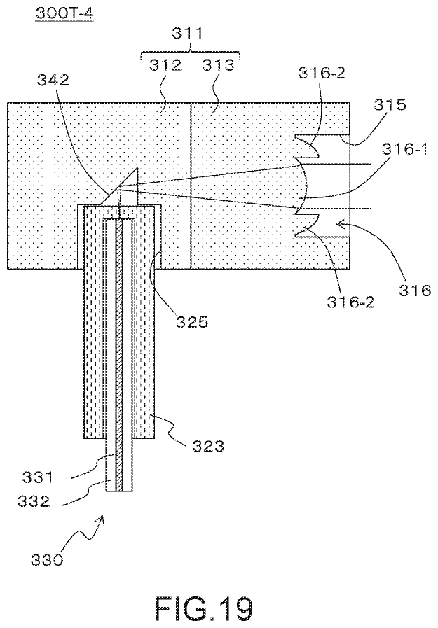

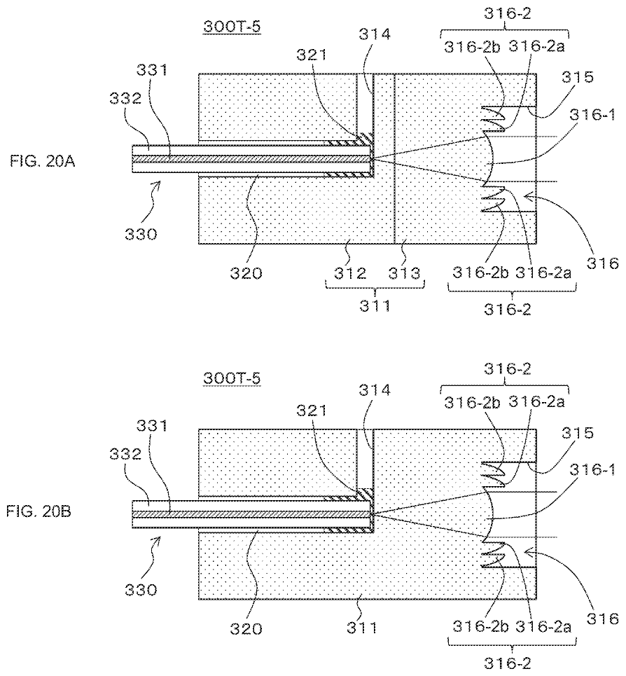

FIG. 19 is a cross-sectional view illustrating a transmission-side optical connector 300T-4 of another configuration example 4. In FIG. 19, a portion corresponding to a portion of (a) of FIG. 13 or FIG. 18 is denoted by the same reference numeral as the portion of (a) of FIG. 13 or FIG. 18, and a detailed description thereof is omitted as appropriate. In the transmission-side optical connector 300T-4, the diameter of the optical fiber inserting hole 325 formed in the first optical section 312 is increased. Further, a ferrule 323 is inserted into the optical fiber inserting hole 325 to be fixed to the optical fiber inserting hole 325 using, for example, an adhesive (not illustrated), where the optical fiber 330 in a state of abutting on the ferrule 323 is fixed to the ferrule 323 in advance. Such a configuration makes it easy to keep the end of the optical fiber 330 at a certain distance from the mirror 342.

“Another Configuration Example 5”

(a) of FIG. 20 is a cross-sectional view illustrating a transmission-side optical connector 300T-5 of another configuration example 5. In (a) of FIG. 20, a portion corresponding to a portion of (a) of FIG. 13 is denoted by the same reference numeral as the portion of (a) of FIG. 13, and a detailed description thereof is omitted as appropriate. In the transmission-side optical connector 300T-5, the second lens portion 316-2 included in the lens 316 has a shape of two rings that are a first ring-shaped portion 316-2a and a second ring-shaped portion 316-2b.

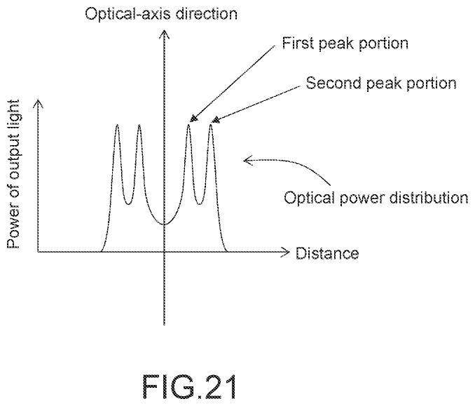

In this case, the lens 316 is designed such that, when light of which a power distribution has two peak portions as illustrated in FIG. 21, light of a first peak portion is formed into perfect collimated light by the first ring-shaped portion 316-2a, and light of a second peak portion is formed into perfect collimated light by the second ring-shaped portion 316-2b. This makes it possible to efficiently reduce a loss with respect to two peak portions when there is an axial deviation.

Note that the example in which the connector body 311 of the transmission-side optical connector 300T-5 is configured by the first optical section 312 and the second optical section 313 being connected to each other, has been described in (a) of FIG. 20. However, the connector body 311 may include a single optical section, as illustrated in (b) of FIG. 20.

<2. Modifications>

The example of using a single-mode optical fiber has been described in the embodiments above. However, the present technology is also applicable when a multimode optical fiber is used. Further, the NA is not limited to a specific NA. Furthermore, the mirror in the embodiments described above may be implemented by another light path changing section. For example, a light path changing section that performs total reflection using difference in refractive index may be adopted.

The example in which the lens 316 forms light into collimated light has been described in the embodiments above. However, the configuration is not limited thereto.

The favorable embodiments of the present disclosure have been described above in detail with reference to the accompanying drawings. However, the technical scope of the present disclosure is not limited to these examples. It is clear that persons who have common knowledge in the technical field of the present disclosure could conceive various alterations or modifications within the scope of a technical idea according to an embodiment of the present disclosure. It is understood that of course such alterations or modifications also fall under the technical scope of the present disclosure.

Further, the effects described herein are not limitative, but are merely descriptive or illustrative. In other words, the technology according to the present disclosure may provide other effects apparent to those skilled in the art from the description herein, in addition to, or instead of the effects described above.

Note that the present technology may also take the following configurations.
(1) An optical connector, including
   a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.
(2) The optical connector according to (1), in which
   the second lens portion has a shape corresponding to a shape of a peak portion of a power distribution of the input light.
(3) The optical connector according to (2), in which
   the peak portion of the power distribution of the input light has a shape of a single ring or two rings.
(4) The optical connector according to any one of (1) to (3), in which
   when the optical axis of the input light coincides the optical axis of the lens, all of the input light is input to the first lens portion, and formation is performed by the first lens portion with respect to the input light.
(5) The optical connector according to (4), in which
   the first lens portion forms the input light into collimated light.
(6) The optical connector according to any one of (1) to (5), in which
   the connector body includes a first optical section to which the light emitter is fixed, and a second optical section that includes the lens.
(7) The optical connector according to any one of (1) to (6), in which
   the light emitter is an optical fiber, and
   the connector body includes an insertion hole into which the optical fiber is inserted.
(8) The optical connector according to any one of (1) to (6), in which
   the light emitter is a light-emitting element that converts an electric signal into an optical signal.
(9) The optical connector according to (8), in which
   the light emitter is connected to the connector body, and
   the light exiting the light emitter enters the lens with no change in a path of the light.
(10) The optical connector according to (8), in which
   the connector body includes a light path changing section used to change a light path, and
   a path of the light exiting the light emitter is changed by the light path changing section to cause the light to enter the lens.
(11) The optical connector according to any one of (1) to (10), in which
   the connector body is made of a light-transmissive material, and integrally includes the lens.
(12) The optical connector according to any one of (1) to (11), in which
   the connector body includes a plurality of the lenses.
(13) The optical connector according to any one of (1) to (12), in which
   the connector body includes a concave light exit portion, and
   the lens is situated in a bottom portion of the light exit portion.
(14) The optical connector according to any one of (1) to (13), in which
   on a side of a front face of the connector body, the connector body integrally includes a convex or concave position regulator used to align the optical connector with a connector to which the optical connector is connected.
(15) The optical connector according to any one of (1) to (14), further including the light emitter.
(16) An optical cable, including
   an optical connector that serves as a plug, the optical connector including a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.
(17) An electronic apparatus, including
   an optical connector that serves as a receptacle, the optical connector including a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.

### REFERENCE SIGNS LIST

100 electronic apparatus
101 optical communication section
102 light-emitting section
103, 104 optical transmission line
105 light-receiving section
200A, 200B optical cable
201A, 201B cable body
300T, 300T-1 to 300T-5 transmission-side optical connector
300R reception-side optical connector
311 connector body
312 first optical section
313 second optical section
314 adhesive injection hole
315 light exit portion
316 lens
316-1 first lens portion
316-2 second lens portion
316-2a first ring-shaped portion
316-2b second ring-shaped portion
317 position regulator
320 optical fiber inserting hole
321 adhesive
323 ferrule
324 light-emitting-element arranging hole
325 optical fiber inserting hole
330 optical fiber
331 core
332 cladding
340 light-emitting element
341 substrate
342 mirror
351 connector body
352 first optical section
353 second optical section
354 adhesive injection hole
355 light entrance portion
356 lens
357 position regulator
358 optical fiber inserting hole
359 adhesive
370 optical fiber
371 core
372 cladding

1. An optical connector, comprising
a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.

2. The optical connector according to claim 1, wherein
the second lens portion has a shape corresponding to a shape of a peak portion of a power distribution of the input light.

3. The optical connector according to claim 2, wherein
the peak portion of the power distribution of the input light has a shape of a single ring or two rings.

4. The optical connector according to claim 1, wherein
when the optical axis of the input light coincides the optical axis of the lens, all of the input light is input to the first lens portion, and formation is performed by the first lens portion with respect to the input light.

5. The optical connector according to claim 4, wherein
the first lens portion forms the input light into collimated light.

6. The optical connector according to claim 1, wherein
the connector body includes a first optical section to which the light emitter is fixed, and a second optical section that includes the lens.

7. The optical connector according to claim 1, wherein
the light emitter is an optical fiber, and
the connector body includes an insertion hole into which the optical fiber is inserted.

8. The optical connector according to claim 1, wherein
the light emitter is a light-emitting element that converts an electric signal into an optical signal.

9. The optical connector according to claim 8, wherein
the light emitter is connected to the connector body, and
the light exiting the light emitter enters the lens with no change in a path of the light.

10. The optical connector according to claim 8, wherein
the connector body includes a light path changing section used to change a light path, and
a path of the light exiting the light emitter is changed by the light path changing section to cause the light to enter the lens.

11. The optical connector according to claim 1, wherein
the connector body is made of a light-transmissive material, and integrally includes the lens.

12. The optical connector according to claim 1, wherein
the connector body includes a plurality of the lenses.

13. The optical connector according to claim 1, wherein
the connector body includes a concave light exit portion, and
the lens is situated in a bottom portion of the light exit portion.

14. The optical connector according to claim 1, wherein
on a side of a front face of the connector body, the connector body integrally includes a convex or concave position regulator used to align the optical connector with a connector to which the optical connector is connected.

15. The optical connector according to claim 1, further comprising the light emitter.

16. An optical cable, comprising
an optical connector that serves as a plug, the optical connector including a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.

17. An electronic apparatus, comprising
an optical connector that serves as a receptacle, the optical connector including a connector body that includes a lens performing formation with respect to light that exits a light emitter, and causing light obtained by the formation to exit the lens, the lens including a circular first lens portion situated in a center portion of the lens, and a ring-shaped second lens portion situated around an outer circumference of the first lens portion, the second lens portion changing a light path of a portion of input light when the portion of the input light is input to the second lens portion, such that the light path of the portion of the input light is oriented toward a direction of an optical axis of the lens, the input light being input light of which an optical axis deviates from the optical axis of the lens.
